(19) United States
(12) Patent Application Publication
(10) Pub. No.: US 2007/0031297 A1
(43) Pub. Date: Feb. 8, 2007

(54) Laboratory microtube

(76) Inventor: Bernard Henri Julien Roussel, Bondy (FR)

Correspondence Address: FOLEY & LARDNER LLP, 150 EAST GILMAN STREET, P.O. BOX 1497, MADISON, WI, 53701-1497, US

(21) Appl. No.: 11/497,807

(22) Filed: Aug. 2, 2006

(30) Foreign Application Priority Data
Aug. 4, 2005 (FR) FR 05 08352

(51) Int. Cl. B01L 3/00

(52) U.S. Cl. 422/102

(57) ABSTRACT

A laboratory microtube capable of enclosing samples of liquid is provided. The microtube includes a body, a cover, and a hinge. The body includes a wall forming a receptacle and a fastening collar formed on at least a portion of a top edge of the wall. The fastening collar includes a contact surface. The cover includes a fastening hook extending from a surface of the cover. The hinge connects the cover with the body. The fastening hook is capable of engaging with the contact surface of the fastening collar. The wall of the body is formed of a material that can be deformed through pressure applied by a user thereby allowing the fastening hook to disengage from the fastening collar when the cover is in a closed position covering the receptacle. After disengaging the fastening hook from the fastening collar, the cover is allowed to open via the hinge.

### FIELD OF THE INVENTION

The subject of the disclosure relates to the field of chemistry or biology laboratory equipment. More specifically, the disclosure relates to microtubes made of synthetic material into which liquid samples are introduced and from which liquid samples are withdrawn using a pipette.

### BACKGROUND OF THE INVENTION

Laboratory microtubes generally are made up of a receptacle of cylindrical external shape or, more generally, of a shape that is conical in its lower part and cylindrical in its upper part; and a cover closing the receptacle. The receptacle and cover may be of the same material so that the microtube is made as a single piece. To this end, the cover may be attached to the receptacle by means of an elastic hinge. The microtube is sealed by the cover through suitable configuration of the top edge of the receptacle and of the underside of the cover to ensure sealed contact between the receptacle and the cover and to keep the receptacle closed unless there is a user intervention. An example of a microtube such as this is described in document EP-A-0 149 797.

In order to gain access to the inside of the receptacle, the user of the microtube breaks the contact between the cover and the receptacle by pulling or pushing vertically against the tab that extends from the cover and generally is located opposite the hinge. When using the microtube, the user can hold the receptacle of the microtube in one hand and open or close the cover with the other hand. This type of operation, however, requires use of both hands. It is also possible for the user to use just one hand (the other hand for example, holding the pipette) and to open or close the cover using their thumb. This operational method, however, may prove difficult, particularly for small-sized microtubes, because there is a risk that the user may drop the microtube as they open it. In addition, during the operation, it is difficult to avoid the user's fingers coming into contact with the top edge of the microtube. As a result, there is a risk of contaminating the inside of the receptacle, and therefore, the liquid sample that it contains or that it will contain once it has been filled. What is needed therefore, is a microtube having a cover that is easily opened by the user using one hand and without risking contamination of the liquid sample.

### SUMMARY OF THE INVENTION

An exemplary embodiment provides a laboratory microtube configuration with a cover that allows quick and easy opening by a user using just one hand without the disadvantages just mentioned. To this end, the laboratory microtube intended to enclose samples of liquid, includes a cover and a receptacle. The cover and the top part of the receptacle allow the microtube to be opened under the action of pressure exerted by the user to the wall of the receptacle near the top part of the receptacle. The pressure tends to locally reduce the diameter of the receptacle in its region of contact with the cover to disengage the latch that holds the cover on the receptacle. An elastic hinge may provide movement of the cover away from the top of the receptacle after the cover is disengaged from the receptacle. As a result, the user has quick access to the inside of the receptacle without touching parts of the microtube other than the outer wall of the receptacle.

In an exemplary embodiment, a microtube for holding samples of liquid includes a body, a cover, and a hinge. The body includes a wall forming a receptacle and a fastening collar formed on at least a portion of a top edge of the wall. The fastening collar includes a contact surface. The cover includes a surface and a fastening hook extending from the surface. The hinge connects the cover with the body. The fastening hook is capable of engaging the contact surface of the fastening collar. The wall of the body is formed of a material that can be deformed through pressure applied by a user thereby allowing the fastening hook to disengage from the fastening collar when the cover is in a closed position covering the receptacle. Through the pressure exerted by the user, the fastening hook and fastening collar are disengaged, and the cover is allowed to open via the hinge.

In another exemplary embodiment, a method of opening a microtube for holding samples of liquid is provided. The microtube includes a body, a cover, and a hinge. The body includes a wall forming a receptacle and a fastening collar formed on at least a portion of a top edge of the wall. The fastening collar includes a contact surface. The cover includes a surface and a fastening hook extending from the surface. The hinge connects the cover with the body. The fastening hook is engaged with the contact surface of the fastening collar. The wall of the body is formed of a material that can be deformed through pressure applied by a user. The method includes exerting pressure on opposed sides of the microtube, disengaging the fastening hook from the contact surface as a result of the exerted pressure, and opening the disengaged cover via the hinge.

Other principal features and advantages of the invention will become apparent to those skilled in the art upon review of the following drawings, the detailed description, and the appended claims.

### BRIEF DESCRIPTION OF THE DRAWINGS

Exemplary embodiments will hereafter be described with reference to the accompanying drawings, wherein like numerals will denote like elements.

FIG. 1a depicts a first side view of a microtube in the closed position as viewed from the front in accordance with an exemplary embodiment.

FIG. 1b depicts a second side view of the microtube of FIG. 1a viewed from 90 degrees relative to FIG. 1a.

FIG. 1c depicts a cross sectional view of the microtube of FIG. 1a.

FIG. 2a depicts a first side view of the microtube of FIG. 1a in an open position.

FIG. 2b depicts a second side view of the microtube of FIG. 2a as viewed from the rear.

FIG. 2c depicts a cross sectional view of the microtube of FIG. 2a.

### DETAILED DESCRIPTION OF THE EXEMPLARY EMBODIMENTS

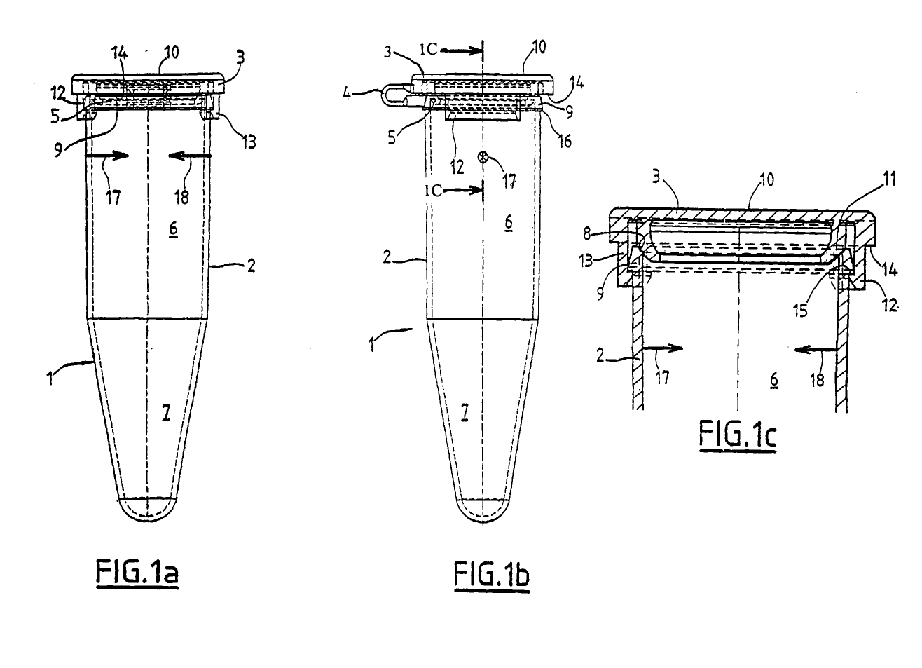

With reference to FIG. 1, a microtube 1 may include a body 2, a cover 3 (or stopper), and a hinge 4. Body 2 includes a wall forming a receptacle. In an exemplary embodiment, microtube 1 is formed of a single piece of material. Hinge 4 may include an elastic, flexible tab that connects the periphery of cover 3 to a top edge 5 of body 2 and allows cover 3 to be opened when contact between cover 3 and the periphery of body 2 is interrupted or weakened. Microtube 1 may be made of a flexible and tough synthetic material such as polypropylene or polyethylene that has the desirable property of chemical inertia with respect to the liquids likely to be introduced into microtube 1.

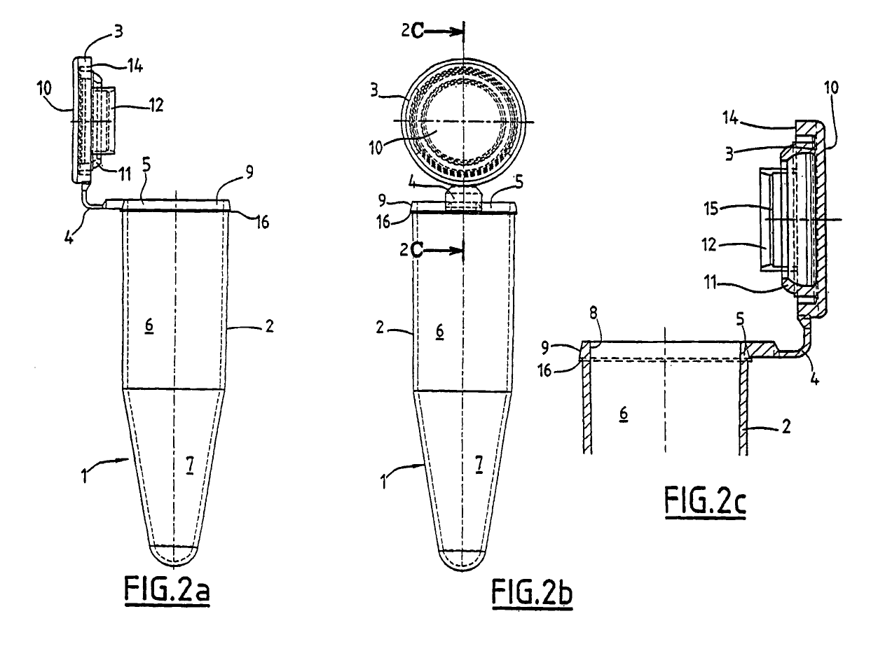

In the exemplary embodiment of FIGS. 1 and 2, body 2 includes a wall forming a receptacle. Body 2 may further include an upper portion 6 having a longitudinal cross section that is cylindrical and a lower portion 7 that is conical. However, body 2 could, for example, be purely cylindrical or purely conical or have a hemispherical lower part. As known to those skilled in the art both now and in the future, body 2, at the periphery of upper portion 6 opposite lower portion 7, may have a sealing surface 8 along an inner surface of the wall. The surface finish and geometry of sealing surface 8 is designed to provide a seal with a corresponding part of cover 3 when cover 3 is closed.

Also, at the periphery of upper portion 6 of body 2 is a fastening collar 9 which is a shoulder formed on an outer surface of the wall of body 2. In the example depicted, fastening collar 9 extends over the entire periphery of body 2 though this is not essential. Generally, fastening collar 9 is present in the region or regions where it interacts with cover 3.

Cover 3 includes a top surface 10 that may provide a marking and identification region that allows information to be written thereon and/or allows fixation of a label or of any other item for identifying the tube. In an exemplary embodiment, top surface 10 is flat. Cover 3 may also include a sealing skirt 11. Sealing skirt 11 is a surface extending from an inner face of top surface 10 that interacts with sealing surface 8. For this purpose, sealing skirt 11 generally is flexible enough to provide a satisfactory seal upon contact with sealing surface 8 and to deform when pressure is exerted on its lateral surface.

Cover 3 also may include a lower surface 14 that extends from the periphery of top surface 10. A plurality of fastening hooks 12, 13 may extend from a portion of lower surface 14. Preferably, fastening hooks 12, 13 are situated on opposed sides of top surface 10. For example, in an embodiment using two fastening hooks 12, 13, fastening hooks 12, 13 are situated 90° on either side of the region of attachment of hinge 4. The lower end of each hook 12, 13 interacts with fastening collar 9 formed in body 2 in such a way that hooks 12, 13 engage with fastening collar 9 as cover 3 is closed. As a result, it is preferable that fastening collar 9 and the surface of hooks 12, 13 exhibit parallel oblique orientations to make it easier to deflect hooks 12, 13 and to slide hooks 12, 13 over fastening collar 9 upon closure as shown with reference to FIG. 1c. Fastening hooks 12, 13 generally should be elastic enough to deflect over and to engage with fastening collar 9, but rigid enough to remain firmly in the engaged position in the absence of any user action aimed at opening microtube 1. Fastening hooks 12, 13 may have sharp corners on a top edge 15 of their lower engaging part that correspond with a contact surface 16 of fastening collar 9 formed at the lower part of fastening collar 9 to improve the quality of the engagement.

In the exemplary embodiment, the contact surfaces of hooks 12, 13 and of fastening collar 9 are horizontal, but they could also be oblique and directed downwards to allow cover 3 to lock itself and to exhibit better resistance to spontaneous opening if a pressure higher than ambient pressure is generated in microtube 1, for example, if a liquid sample contained in microtube 1 is heated.

Upon closing cover 3 (switching from the configuration of FIG. 2 to the configuration of FIG. 1), the user moves cover 3 down towards body 2. Hinge 4 facilitates the correct mutual positioning between cover 3 and body 2. Fastening hooks 12, 13 and fastening collar 9 are aligned, and sealing skirt 11 of cover 3 contacts sealing surface 8 of body 2. Fastening hooks 12, 13 are preferably more rigid than fastening collar 9. When fastening hooks 12, 13 contact fastening collar 9 under the effect of pressure exerted by the user, fastening hooks 12, 13 are pushed back over fastening collar 9. As the pressure is exerted on cover 3, fastening hooks 12, 13 slip under contact surface 16 of fastening collar 9. Fastening collar 9 reverts back to its initial shape. Cover 3 is in the closed position relative to body 2 through the contact between fastening hooks 12, 13 and contact surface 16 of fastening collar 9. The dimensions and the mechanical properties of the various parts of microtube 1 are such that when the pressure exerted by the user on cover 3 ceases, cover 3 remains in an engaged position in which contact between sealing surface 8 and sealing skirt 11 seals the periphery of the top edge of body 2. A pulling action exerted on cover 3 in the opposite direction to the closing pressure does not allow cover 3 to be opened without excessive force and without damaging microtube 1.

Instead, to open cover 3, the user holds body 2 of microtube 1 between two fingers placed generally under fastening hooks 12, 13 and near the top edge of body 2. Using these fingers, the user exerts a pressure on the wall of body 2, for example, in the direction of arrows 17, 18 shown with reference to FIGS. 1a, 1b, and 1c. The exerted pressure causes deformation of body 2 and brings the two opposed regions of fastening collar 9 that interact with fastening hooks 12, 13 closer together. Sealing skirt 11 also exhibits sufficient deformability that it can adopt an ovalized shape allowing the two regions of fastening collar 9 to move closer together. The deformation allows fastening hooks 12, 13 to disengage from fastening collar 9.

With cover 3 thus disengaged, there is no longer anything to prevent hinge 4 from raising cover 3. As a result, microtube 1 is placed in the open position, as shown with reference to FIGS. 2a, 2b, and 2c, using a simple and reliable movement of just two fingers and with no contact between the user's fingers and the edge of microtube 1. As a result, there is no risk of contamination of any liquid sample introduced into or withdrawn from microtube 1. In the open position of microtube 1, the pipette can be introduced into microtube 1.

The following microtube 1 characteristics describe an exemplary embodiment of a microtube 1 having a capacity of a few milliliters. The characteristics are provided for exemplification only and are not intended to limit the characteristics of microtube 1 in any way. Microtube 1 may be made of polypropylene, have a length of 41 millimeters (mm) when microtube 1 is closed, and have a diameter of 13.2 mm in the region of upper portion 6. The wall thickness of upper portion 6 may be less than 0.5 mm so that the wall has the flexibility needed for cover 3 to be opened simply by pressing against the wall of body 2. Fastening collar 9 may be 1.3 mm tall with a maximum thickness at its base of 0.75 mm. Fastening collar 9 may have a conical shape, with a cone angle of approximately 26° to make it easier for fastening collar 9 to engage fastening hook(s) 12, 13. The thickness of fastening hooks 12, 13 between a lower edge and the surface that catches on contact surface 16 of fastening collar 9 is 0.75 mm so that the hook is sufficiently rigid. The breadth of the active engagement surface between fastening hook(s) 12, 13 and the surface of contact surface 16 of fastening collar 9 may be 0.25 mm. Contact surface 16 may be a sharp edge to guarantee engagement though this is not essential. The shape of fastening hooks 12, 13 also may be conical with a cone angle of approximately 26° to make it easier for fastening collar 9 to engage with fastening hooks 12, 13. Sealing skirt 11 may be less than 0.4 mm thick to provide the necessary deformability.

Of course variations can be made to the invention as described and depicted. In particular, additional or fewer fastening hooks 12, 13 may be used. For example, a single hook may be used that preferably is positioned opposite hinge 4. Additionally, fastening hooks 12, 13 may be broken down into one or more groups of several hooks. For cover 3 to open correctly and easily as a result of a simple action on the part of the user, the groups of hooks may be concentrated in opposed angular sectors of cover 3.

Additionally, sealing skirt 11 is not needed if the sealing that it provides is not essential based on the intended use of microtube 1. However, sealing skirt 11 exerts a force on fastening collar 9 when cover 3 is in the closed and engaged position to assist in maintaining fastening hooks 12, 13 in the engaged position.

The foregoing description of exemplary embodiments of the invention have been presented for purposes of illustration and of description. It is not intended to be exhaustive or to limit the invention to the precise form disclosed, and modifications and variations are possible in light of the above teachings or may be acquired from practice of the invention. The embodiments were chosen and described in order to explain the principles of the invention and as practical applications of the invention to enable one skilled in the art to utilize the invention in various embodiments and with various modifications as suited to the particular use contemplated. It is intended that the scope of the invention be defined by the claims appended hereto and their equivalents.

What is claimed is:

1. A microtube for holding samples of liquid, comprising:
a body including a wall forming a receptacle and a fastening collar formed on at least a portion of a top edge of the wall, the fastening collar including a contact surface;
a cover, the cover including a surface and a fastening hook extending from the surface; and
a hinge connecting the cover with the body;
wherein the fastening hook is capable of engaging the contact surface of the fastening collar; and
further wherein the wall of the body is formed of a material that can be deformed through pressure applied by a user thereby allowing the fastening hook to disengage from the fastening collar when the cover is in a closed position covering the receptacle and further allowing the cover to open via the hinge.

2. The microtube of claim 1, further comprising a sealing skirt connected to an inner face of the cover.

3. The microtube of claim 2, further comprising a sealing surface on an inner surface of the wall, wherein the sealing surface interacts with the sealing skirt to form a seal between the cover and the body when the cover is in the closed position covering the receptacle, and further wherein the sealing surface is capable of being deformed by the user.

4. The microtube of claim 1, wherein the fastening hook is formed opposite the hinge.

5. The microtube of claim 1, further comprising a plurality of fastening hooks.

6. The microtube of claim 5, wherein the plurality of fastening hooks are formed on opposed sides of the surface of the cover.

7. The microtube of claim 5, wherein the plurality of fastening hooks are formed in groups.

8. The microtube of claim 1, further comprising a second fastening hook, wherein the fastening hook and the second fastening hook are formed at approximately 90° on either side of the hinge.

9. The microtube of claim 1, wherein the fastening hook includes a firs oblique surface and the fastening collar includes a second oblique surface and further wherein the first oblique surface and the second oblique surface have parallel orientations.

10. The microtube of claim 1, wherein the hinge is formed of an elastic material.

11. The microtube of claim 1, wherein the body, the cover, and the hinge are formed as a single piece.

12. The microtube of claim 11, wherein the body, the cover, and the hinge are formed of the same material.

13. A method of opening a microtube for holding samples of liquid, the method comprising:
exerting pressure on opposed sides of a microtube, wherein the microtube comprises
a body including a wall forming a receptacle and a fastening collar formed on at least a portion of a top edge of the wall, the fastening collar including a contact surface;
a cover, the cover including a surface and a fastening hook extending from the surface; and
a hinge connecting the cover with the body;
wherein the fastening hook is engaged with the contact surface of the fastening collar; and
further wherein the wall of the body is formed of a material that can be deformed through pressure applied by a user;
disengaging the fastening hook from the contact surface as a result of the exerted pressure; and
opening the disengaged cover via the hinge.
